(19) United States
(12) Patent Application Publication
(10) Pub. No.: US 2013/0044207 A1
(43) Pub. Date: Feb. 21, 2013

(54) Imaging apparatus

(71) Applicant: Johan Calcoen, Leuven (BE)

(72) Inventor: Johan Calcoen, Leuven (BE)

(73) Assignee: Key Technology, Inc.

(21) Appl. No.: 13/136,956

(22) Filed: Aug. 16, 2011

(51) Int. Cl. H04N 7/18

(52) U.S. Cl. 348/91; 348/E07.085

(57) ABSTRACT

An imaging apparatus is described, and which includes a first light source, which when energized, emits nonvisible near infrared electromagnetic radiation which is directed at an object of interest to be imaged, and which is reflected therefrom; a second light source, which when energized, emits a given wavelength of invisible electromagnetic radiation which is directed at the object of interest to be imaged, and which is reflected therefrom; a first optical filter which is operable to pass, at least in part, both the reflected near infrared, and invisible electromagnetic radiation reflected from the object of interest; and a single camera operably positioned to receive the electromagnetic radiation passed by the first optical filter and produce a resulting image of the object of interest from both the invisible and near infrared electromagnetic radiation which is passed by the optical filter.

The present invention relates to an imaging apparatus, and more specifically to an imaging apparatus which finds usefulness in a sorting device for food or other consumable products of various types, and which illuminates the product to be sorted with both invisible light, and near infrared radiation, and which further produces a resulting visibly discernable image formed of both the invisible and near infrared radiation by employing a single camera.

A first aspect of the present invention relates to an imaging apparatus which includes a first light source which when energized emits nonvisible near infrared electromagnetic radiation which is directed at an object of interest to be imaged, and which is reflected therefrom; a second light source, which when energized, emits a given wavelength of invisible electromagnetic radiation which is directed at the object of interest to be imaged, and which is reflected therefrom; a first optical filter which is operable to pass, at least in part, both the reflected near infrared, and invisible electromagnetic radiation reflected from the object of interest; and a camera operably positioned to receive the electromagnetic radiation passed by the first optical filter and produce a resulting image of the object of interest from both the invisible and near infrared electromagnetic radiation which is passed by the optical filter.

Another aspect of the present invention relates to an imaging apparatus for inspecting objects of interest and which includes a first light source which, when selectively energized, emits non visible near infrared electromagnetic radiation which is directed towards a multiplicity of objects of interest to be inspected, and sorted, and which are moving along a given path of travel, and wherein the multiplicity of objects of interest include both acceptable and unacceptable objects of interest, and wherein the first light source is selectively energized and moves along a predetermined path of travel which is substantially transverse relative to the path of travel of the multiplicity of objects of interest; a second light source, which when selectively energized either alone, or in unison with the first light source, emits predetermined invisible electromagnetic radiation which is directed towards the multiplicity of objects of interest, and along the same predetermined path of travel, and wherein the emitted electromagnetic radiation of the energized first and second light sources are reflected from the multiplicity of the objects of interest; an optical filter which is operable to pass predetermined bands of near infrared, and visible electromagnetic radiation which is reflected from the multiplicity of the objects of interest; a camera positioned in optical receiving relation relative to the aforementioned optical filter to process the invisible and near infrared electromagnetic radiation which is passed by the optical filter, and which further produces a resulting image formed from both the invisible and near infrared electromagnetic radiation which is reflected from the multiplicity of objects of interest; a general purpose computer which receives and evaluates the resulting image formed by the camera, and identifies unacceptable objects of interest within the multiplicity of objects of interest which are being inspected; and an ejector assembly operably coupled to the general purpose computer and which removes the unacceptable objects of interest which are identified by the general purpose computer.

Still another aspect of the present invention relates to a method for imaging an object of interest which includes the steps of providing a first optical filter for passing at least two discrete bands of electromagnetic radiation having individual wavelengths which are both invisible, and near infrared; positioning a camera for receiving and processing the electromagnetic radiation which is passed by the first optical filter, and wherein the camera provides a resulting image formed from both of the discrete bands of electromagnetic radiation; providing a first light source which, when energized, emits electromagnetic radiation having near infrared wavelengths, and which is directed at an object of interest to be inspected, and then reflected back in the direction of the first optical filter; providing a second optical filter which passes the electromagnetic radiation which is emitted by the first light source; providing a second light source which, when energized, emits electromagnetic radiation having wavelengths which are invisible, and which are directed at an object of interest to be inspected, and then reflected from the object of interest in the direction of the first optical filter; selectively and sequentially energizing the first light source, and then the first and second light sources in unison; generating a first electrical signal with the camera and which corresponds to the reflected electromagnetic radiation which is generated by the first light source and which is further reflected by the object of interest and passed by the first optical filter so as to be received within the camera; generating a second electrical signal with the camera and which corresponds to the reflected electromagnetic radiation which is generated by the simultaneous energizing of the first and second light sources and which is passed by the first optical filter as to be received within the camera; and subtracting the second electrical signal from the first electrical signal to produce the resulting image generated by the camera.

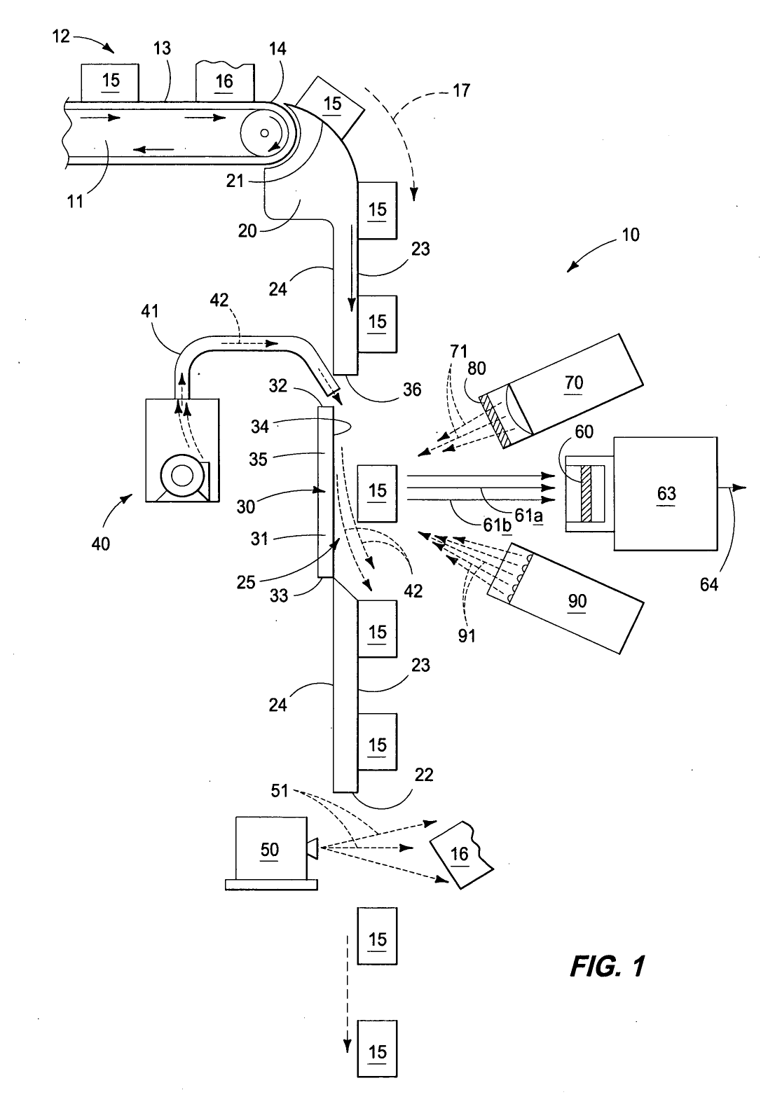

The visual reference 30 as briefly discussed, above, provides a suitable surface which reflects emitted electromagnetic radiation as will be discussed hereinafter so that it may be directed at, and received by, a suitable electromagnetic detecting sensor, or other camera as will be discussed, below. As should be understood, the visual reference 30 provides a means for easily calibrating or adjusting the imaging apparatus 10 while it is in operation so as to ensure that accurate images of the food product or other objects of interest 12 which are moving across the gap 25 are being produced. As seen in FIG. 1, the visual reference 30 has a main body 31 with a first end 32, and an opposite second end 33 which is affixed to the inwardly facing surface 24 of the downwardly directed supporting surface 20 in the manner as seen. The visual reference 30 has an outwardly facing surface 34 which is coated or otherwise provided with a reflective surface which provides a convenient means whereby the present apparatus 10 may be visually calibrated or adjusted while in operation. Additionally, it will be seen that the first end 32 is spaced from the inwardly facing surface 24 of the downwardly directed supporting surface 20 in a manner as to provide a gap or other passageway 36. This gap or passageway 36, as will be discussed below, permits a flow of pressurized air to move there-through and into the gap 25.

The present invention 10 also includes a first optical filter 60 for passing at least two discrete bands of electromagnetic radiation 61 having individual wavelengths which are both invisible spectrum 61a and near infrared 61b. The present invention 10 also includes a camera 63 which is positioned to receive and process the electromagnetic radiation 61 which is passed by the first optical filter 60. The camera 63 provides a resulting image formed from both the discrete bands of electromagnetic radiation, and provides an output signal 64 which is then later processed by a general purpose computer 65 as will be described in greater detail below. A suitable first optical filter 60 may be purchased under the trademark/name Kodak Wratten Gelatin Filters and which are commercially available from various sources.

The present invention further includes a second optical filter 80 which is positioned in a location so that it passes the electromagnetic radiation 71 which is emitted by the first light source 70. The second optical filter 80 passes the near infrared radiation 71 having a given predetermined wavelength or wavelengths. In the invention as shown in FIG. 1, a second light source 90 is also provided and which, when energized, emits electromagnetic radiation 91 having wavelengths which are invisible, and which are directed at the objects of interest which may includes acceptable and unacceptable products 15 and 16, respectively, and which are subject to inspection and then are reflected 61 b from these same objects of interest back in the direction of the first optical filter 60.

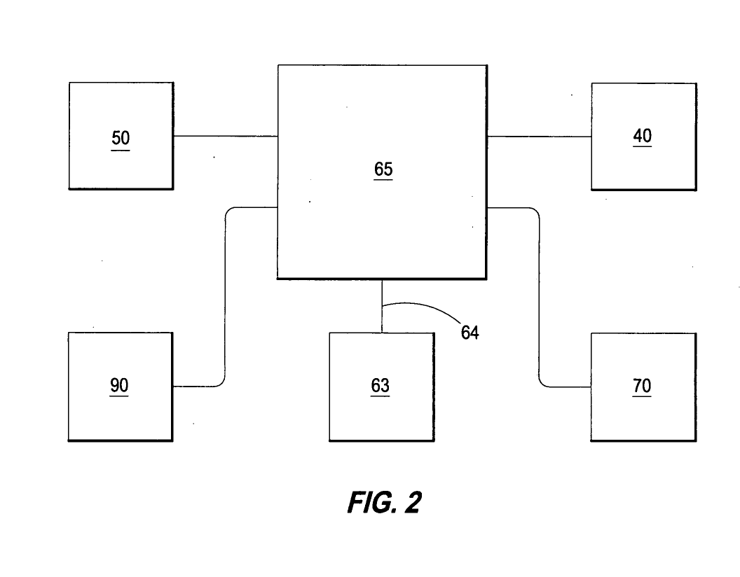

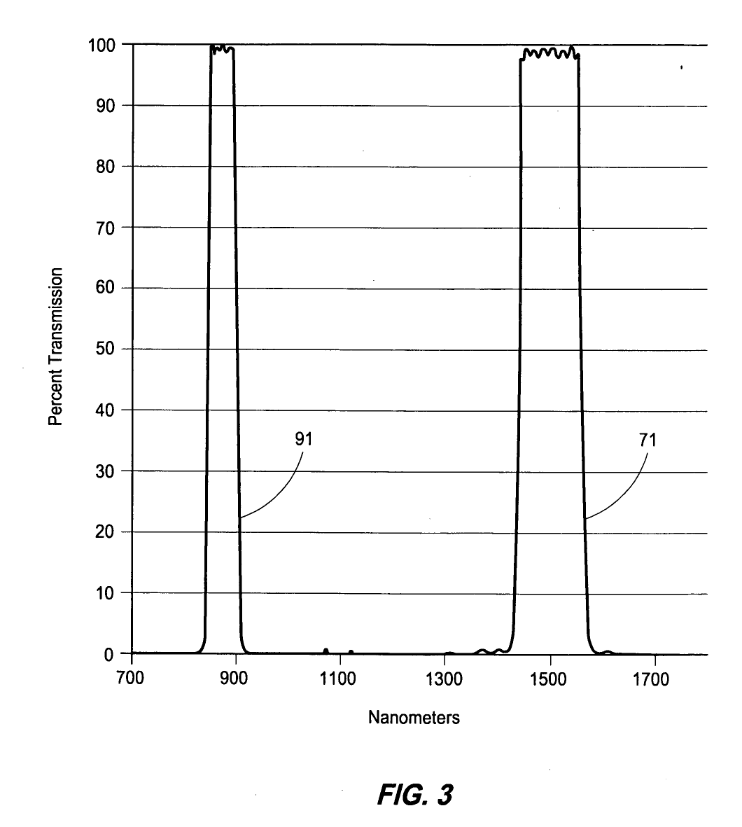

In its broadest aspect, an imaging apparatus 10 is shown in FIG. 1 and which includes a first light source 70 which when energized emits nonvisible near infrared electromagnetic radiation 71 which is directed at an object of interest to be imaged 15 or 16, and which is reflected therefrom 61. The imaging apparatus 10 includes a second light source 90, which when energized, emits given wavelengths of invisible electromagnetic radiation 91 which is directed at the object of interest to be imaged 15 or 16, and which is reflected therefrom. The invention 10 further includes a first optical filter 60 which is operable to pass, at least in part, both the reflected near infrared, and invisible electromagnetic radiation 61a and 61b, respectively, which is reflected from the objects of interest to be inspected 15 or 16. Further, the invention 10 includes a camera 63 which is operably positioned to receive the reflected electromagnetic radiation 61a and 61b which is passed by the first optical filter 60, and produce a resulting image of the object of interest from both the invisible and near infrared electromagnetic radiation which is passed by the optical filter 60. In the arrangement as seen in the drawings, the invention also includes a second optical filter 80 which passes the near infrared electromagnetic radiation 71 which is produced by the first light source 70 and which is directed at the object of interest 15 and/or 16. In the arrangement as seen, the second optical filter passes only electromagnetic radiation greater than a given wavelength which is typically about 1,000 nanometers. As earlier discussed, the first light source 71 may include a halogen lamp of conventional design. Furthermore, it should be recognized that the first light source 71 may also comprise a multiplicity of light emitting diodes (not shown) which emit non-visible near infrared radiation 71. In the arrangement as seen in the drawings, the general purpose computer 65 as shown in the schematic view of FIG. 2 may be rendered operable to selectively energize the first light source 70 which may comprise a multiplicity of light emitting diodes in unison or selectively for given periods of time. If a multiplicity of light emitting diodes are provided for the first light source 70, the individual light emitting diodes when individually energized may emit discreet and different wavelengths of near infrared electromagnetic radiation. As seen in FIG. 1, the second light source 90 may comprise a multiplicity of light emitting diodes which, when energized, emit electromagnetic radiation 91 having wavelengths of about 870 nanometers. As earlier discussed, the first optical filter 60 is selected so that it is operable to pass both invisible electromagnetic radiation 61 a emitted by the second light source 91, as well as the near infrared electromagnetic radiation 61b which is generated by the first light source 70. In the arrangement as seen in FIG. 1, the first optical filter passes wavelengths of invisible electromagnetic radiation 61a and 61b which lie in the range of about 850 to about 900 nanometers, and about 1450 to about 1550 nanometers. This is best depicted by a study of FIG. 3. The general purpose computer 65 provides a means for selectively and sequentially energizing the first light source 70; and then secondly, energizing both the first, and second light sources 70 and 90 together in unison. This sequential energizing of the first and second light sources 70 and 90 provides a signal output 64 from the camera 63 which can then be processed by the general purpose computer. More specifically, upon first selectively energizing the first light source 70, the camera 63 generates a first electrical signal which corresponds to the reflected near infrared electromagnetic radiation 71 which is passed by the first optical filter 60. Further, upon secondly, energizing the first and second light sources 70 and 90 in unison, the camera 63 generates a second electrical signal which corresponds to the reflected near infrared and invisible electromagnetic radiation passed by the first optical filter 60. A resulting image of the object of interest 15 or 16 is derived and produced by the camera 63 and by the general purpose computer 65 by subtracting the second electrical image from the first electrical signal. In the arrangement as seen in FIG. 1, the imaging device 10 repeatedly images along a given path of travel which is substantially transverse to the predetermined direction of travel 17 of the objects of interest. The resulting image is employed by the general purpose computer to identify, and then remove defective objects of interest 16 from the multiplicity of objects which are being inspected. The general purpose computer then sends a suitable signal to the ejector assembly 50 to remove unacceptable articles 16 from the product stream.

In the drawings as provided, an imaging apparatus 10 for inspecting objects of interest 15 and 16 include a first light source 70 which, when selectively energized, emits non visible infrared electromagnetic radiation 71 which is directed towards a multiplicity of objects of interest to be inspected 15 and 16, and sorted, and which are moving along a given path of travel 17. The multiplicity of objects of interest 15 and 16 include both acceptable 15 and unacceptable 16 objects of interest. The first light source 70 is selectively energized and moves along a predetermined path of travel which is substantially transverse to the path of travel 17 of the multiplicity of objects of interest. In the invention as seen, a second light source 90 is provided, and which when selectively energized either alone, or in unison with the first light source 70 emits predetermined a invisible electromagnetic radiation 91 which is directed towards the multiplicity of objects of interest 15 and 16, and along the same predetermined path of travel. The emitted electromagnetic radiation 71, 91 of the energized first and second light sources 70, 90 are reflected from the multiplicity of the objects of interest 61. The present invention 10 includes an optical filter 60 which is operable to pass predetermined bands of near infrared, and invisible electromagnetic radiation 61a and 61b, respectively, which are reflected from the multiplicity. of the objects of interest 15/16 which are passing through the gap 25 as seen in FIG. 1. A camera or other electromagnetic radiation sensor 63 is positioned in optical receiving relation relative to the optical filter 60 to process the invisible and near infrared electromagnetic radiation 61 which is passed by the optical filter 63. The camera 63 produces a resulting image 64 formed from both the invisible and near infrared electromagnetic radiation which is reflected from the multiplicity of objects of interest 15 and 16 passing through the gap as earlier described. The present invention also includes an ejector assembly 50 which is operably coupled to a general purpose computer 63, and which removes the unacceptable objects of interest 16 which are identified by the general purpose computer 63 from the resulting image formed by the camera. In the arrangement as seen in the drawings, the invention 10 also includes a second optical filter 80 located adjacent to the first light source 70, and which passes emitted near infrared radiation having a predetermined wavelength.

The present invention also includes a method for imaging an object of interest 15/16. In particular, the steps of this methodology include a first step of providing a first optical filter 60 for passing at least two discrete bands of reflected electromagnetic radiation 61 a and 61 b which are both invisible, and near infrared. The methodology includes a second step of positioning a camera 63 for receiving and processing the electromagnetic radiation 61 which is passed by the first optical filter, and wherein the camera 63 provides a resulting image 64 formed from both of the discrete bands of electromagnetic radiation 61. The methodology also includes another step of providing a first light source 70 which, when energized, emits electromagnetic radiation 71 having near infrared wavelengths, and which are directed at an object of interest to be inspected 15/16, and then reflected back in the direction of the first optical filter 60. The methodology includes another step of providing a second optical filter 80 which passes the electromagnetic radiation 71 which is emitted by the first light source 70. The methodology also includes another step of providing a second light source 90 which, when energized, emits electromagnetic radiation 91 having wavelengths which are invisible, and which are directed at the objects of interest to be inspected 15/16, and then reflected from the objects of interest in the direction of the first optical filter 60. The methodology includes another step of selectively and sequentially energizing the first light source 70; and then the first light source 70, and the second light sources 90, in unison. The methodology also includes another step of generating a first electrical signal 64 with the camera 63 and which corresponds to the reflected electromagnetic radiation which is generated by the first light source 71 and which is further reflected by the objects of interest 15/16 and then passed by the first optical filter 60 so as to be received within the camera 63. The methodology also includes another step of generating a second electrical signal 64 with the camera 63 and which corresponds to the reflected electromagnetic radiation which is generated by the simultaneous energizing of the first and second light sources 70 and 90 and which is passed by the first optical filter 60 so as to be received within the camera 63. Finally, the methodology includes a step of subtracting the second electrical signal from the first electrical signal by means of the general purpose computer 63 to produce the resulting image generated by the camera 63.

Therefore, it will be seen that the present invention provides a convenient means whereby an object to be inspected 15/16 may be illuminated by both near infrared and invisible electromagnetic radiation sources and thereafter, by use of a single camera or other electromagnetic radiation sensor may form an image formed of both the emitted near infrared radiation and invisible radiation so as to provide a resulting image which provides a means by which an object of interest may be sorted conveniently in a manner not possible heretofore.

1. An imaging apparatus, comprising:
a first light source which when energized emits nonvisible near infrared electromagnetic radiation which is directed at an object of interest to be imaged, and which is reflected therefrom;
a second light source, which when energized, emits a given wavelength of invisible electromagnetic radiation which is directed at the object of interest to be imaged, and which is reflected therefrom;
a first optical filter which is operable to pass, at least in part, both the reflected near infrared, and invisible electromagnetic radiation reflected from the object of interest; and
a camera operably positioned to receive the electromagnetic radiation passed by the first optical filter and produce a resulting image of the object of interest from both the invisible and near infrared electromagnetic radiation which is passed by the optical filter.

2. An imaging apparatus as claimed in claim 1, and further comprising:
a second optical filter which passes the near infrared electromagnetic radiation which is produced by the first light source and which is directed at the object of interest, and wherein the second optical filter passes only electromagnetic radiation greater than a given wavelength.

3. An imaging apparatus as claimed in claim 1, and wherein the first light source comprises a halogen lamp which generates near infrared electromagnetic radiation with wavelengths greater than 1000 nanometers.

4. An imaging apparatus as claimed in claim 2, and wherein the second optical filter does not pass wavelengths of electromagnetic radiation which are less than about 1000 nanometers.

5. An imaging apparatus as claimed in claim 1, and wherein the first light source comprises a multiplicity of light emitting diodes which emit the non visible near infrared radiation.

6. An imaging apparatus as claimed in claim 5, and wherein the multiplicity of light emitting diodes are selectively energized in unison.

7. An imaging apparatus as claimed in claim 5, and wherein the multiplicity of light emitting diodes are individually selectively energized for given periods of time.

8. An imaging apparatus as claimed in claim 5, and wherein the multiplicity of light emitting diodes when individually energized emit discreet and different wavelengths of near infrared electromagnetic radiation.

9. An imaging apparatus as claimed in claim 1, and wherein the second light source comprises a multiplicity of light emitting diodes which, when energized, emit electromagnetic radiation have a wavelength of about 870 nanometers.

10. An imaging apparatus as claimed in claim 1, and wherein the first optical filter passes the near infrared wavelengths of the electromagnetic radiation emitted by the energized first light source, and the invisible electromagnetic radiation emitted by the energized second light source.

11. An imaging apparatus as claimed in claim 1, and wherein the first optical filter passes wavelengths of electromagnetic radiation which lie in the range of about 850 to about 900 nanometers, and about 1450 to about 1550 nanometers.

12. An imaging apparatus as claimed in claim 1, and further comprising:
means for first selectively and sequentially energizing the first light source, and then secondly energizing both the first and second light sources in unison.

13. An imaging apparatus as claimed in claim 12, and wherein, upon first selectively energizing the first light source, the camera generates a first electrical signal which corresponds to the reflected near infrared electromagnetic radiation passed by the first optical filter, and wherein upon secondly, energizing the first and second light sources in unison, the camera generates a second electrical signal which corresponds to the reflected near infrared and invisible electromagnetic radiation passed by the first optical filter, and wherein a resulting image of the object of interest is derived and produced by the camera by subtracting the second electrical signal from the first electrical signal.

14. An imaging apparatus as claimed in claim 13, and wherein the object of interest comprises a multiplicity of objects of interest to be inspected, and sorted, and wherein the imaging device repeatedly images along a given path of travel which is substantially transverse to a predetermined direction of travel of the objects of interest.

15. An imaging apparatus as claimed in claim 13, and wherein the resulting image is employed to identify, and then remove defective objects of interest from the multiplicity of objects of interest which are being inspected.

16. An imaging apparatus for inspecting objects of interest, comprising:
a first light source which, when selectively energized, emits non visible near infrared electromagnetic radiation which is directed towards a multiplicity of objects of interest to be inspected, and sorted, and which are moving along a given path of travel, and wherein the multiplicity of objects of interest include both acceptable and unacceptable objects of interest, and wherein the first light source is selectively energized and moves along a predetermined path of travel which is substantially transverse to the path of travel of the multiplicity of objects of interest;
a second light source, which when selectively energized either alone, or in unison with the first light source emits predetermined invisible electromagnetic radiation which is directed towards the multiplicity of objects of interest, and along the same predetermined path of travel, and wherein the emitted electromagnetic radiation of the energized first and second light sources are reflected from the multiplicity of the objects of interest;
an optical filter which is operable to pass predetermined bands of near infrared, and invisible electromagnetic radiation which is reflected from the multiplicity of the objects of interest;
a camera positioned in optical receiving relation relative to the optical filter to process the invisible and near infrared electromagnetic radiation which is passed by the optical filter, and which produces a resulting image formed from both the invisible and near infrared electromagnetic radiation which is reflected from the multiplicity of objects of interest;
a general purpose computer which receives and evaluates the resulting image formed by the camera and identifies unacceptable objects of interest within the multiplicity of objects of interest which are being inspected; and
an ejector assembly operably coupled to the general purpose computer and which removes the unacceptable objects of interest which are identified by the general purpose computer.

17. An imaging apparatus as claimed in claim 16, and wherein the first light source, when energized, emits near infrared electromagnetic radiation which lies within a predetermined band.

18. An imaging apparatus as claimed in claim 16, and wherein the first light source, when selectively energized, emits near infrared electromagnetic radiation in a plurality of predetermined, and discrete bands.

19. An imaging apparatus as claimed in claim 16, and wherein the first light source comprises a halogen lamp.

20. An imaging apparatus as claimed in claim 19, and further comprising:
a second optical filter located adjacent to the first light source, and which passes emitted near infrared radiation having a predetermined wavelength.

21. An imaging apparatus as claimed in claim 16, and wherein the second light source comprises a multiplicity of light emitting diodes which emit visible electromagnetic radiation having a predetermined wavelength.

22. A method for imaging an object of interest, comprising:
providing a first optical filter for passing at least two discrete bands of electromagnetic radiation having individual wavelengths which are invisible, and near infrared;
positioning a camera for receiving and processing the electromagnetic radiation which is passed by the first optical filter, and wherein the camera provides a resulting image formed from both of the discrete bands of electromagnetic radiation;
providing a first light source which, when energized, emits electromagnetic radiation having near infrared wavelengths, and which is directed at an object of interest to be inspected, and then reflected back in the direction of the first optical filter;
providing a second optical filter which passes the electromagnetic radiation which is emitted by the first light source;
providing a second light source which, when energized, emits electromagnetic radiation having wavelengths which are invisible, and which are directed at an object of interest to be inspected, and then reflected from the object of interest in the direction of the first optical filter;
selectively and sequentially energizing the first light source, and then the first and second light sources in unison;
generating a first electrical signal with the camera and which corresponds to the reflected electromagnetic radiation which is generated by the first light source and which is further reflected by the object of interest and passed by the first optical filter so as to be received within the camera;
generating a second electrical signal with the camera and which corresponds to the reflected electromagnetic radiation which is generated by the simultaneous energizing of the first and second light sources and which is passed by the first optical filter as to be received within the camera; and
subtracting the second electrical signal from the first electrical signal to produce the resulting image generated by the camera.
